(19) United States
(12) Patent Application Publication
(10) Pub. No.: US 2018/0345555 A1
(43) Pub. Date: Dec. 6, 2018

(54) INDUSTRIAL MACHINE SYSTEM AND CONTROL METHOD OF INDUSTRIAL MACHINE SYSTEM

(71) Applicant: FANUC CORPORATION, Yamanashi (JP)

(72) Inventor: Tatsuhiro UCHIYAMA, Yamanashi (JP)

(21) Appl. No.: 15/997,860

(22) Filed: Jun. 5, 2018

(30) Foreign Application Priority Data
Jun. 6, 2017 (JP) 2017-111502

(51) Int. Cl. B29C 45/76; G06F 3/0481

(52) U.S. Cl. CPC B29C 45/76; B29C 2045/7606; G06F 3/0481

(57) ABSTRACT

A management device connected to a control device includes multiple interface processing units respectively corresponding to a plurality of types of display screens. A selection and execution unit selects one from the interface processing units, and the selected interface processing unit controls the display unit so as to cause the display unit of the control device to display the associated display screen and display the input information on the display screen of the display unit.

### CROSS-REFERENCE TO RELATED APPLICATION

This application is based upon and claims the benefit of priority from Japanese Patent Application No. 2017-111502 filed on Jun. 6, 2017, the contents of which are incorporated herein by reference.

### BACKGROUND OF THE INVENTION

### Field of the Invention

The present invention relates to an industrial machine system having a control device for controlling an industrial machine and a management device connected with the control device by a communication link, as well as a control method for the industrial machine system.

### Description of the Related Art

Japanese Laid-Open Patent Publication No. 2004-503039 (PCT) discloses a device which enables the display of the control panel for a machine controller to be customized.

### SUMMARY OF THE INVENTION

Various pieces of information for driving an industrial machine are displayed on the display unit of the control device for controlling the industrial machine. For the display, it is preferable, for example, that the display screen of the display unit can be switched depending on the operator's skill level for the industrial machine. However, setting multiple types of display screens may increase the processing load on the control device.

The present invention has been devised to solve the above problem, it is therefore an object of the present invention to provide an industrial machine system in which the processing load on the control device can be suppressed, as well as a control method of the industrial machine system.

An aspect of the present invention resides in an industrial machine system, comprising: a control device configured to control an industrial machine; and a management device connected to the control device, wherein: the control device includes a display unit configured to display a display screen and an input information receiving unit configured to receive input information entered by an operator; the management device includes a plurality of interface processing units provided in association with types of the display screens to be displayed on the display unit, and a selection and execution unit configured to select one from the plurality of interface processing units according to information for selection for selecting the type of the display screen to be displayed on the display unit and cause the selected interface processing unit to execute processing; and each of the selected interface processing units is configured to control the display unit so as to cause the display unit to display the associated display screen and display the input information on the display screen of the display unit.

According to the present invention, it is possible to suppress the processing load on the control device.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic diagram showing a configuration of an industrial machine system;

FIG. 2 is a functional block diagram showing a functional configuration of a control device and a management device; and

FIG. 3 is a flowchart showing a processing flow performed in a control device and a management device.

### DESCRIPTION OF THE PREFERRED EMBODIMENTS

### First Embodiment

### Configuration of Industrial Machine System

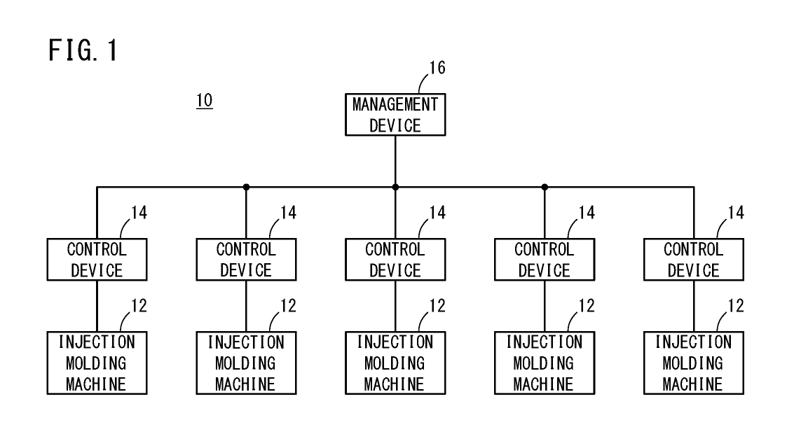

FIG. 1 is a schematic diagram showing a configuration of an industrial machine system 10 according to the present embodiment. The industrial machine system 10 has a plurality of sets of an injection molding machine 12 (industrial machine) and a control device 14 for controlling the injection molding machine 12, and a single management device 16 connected to the multiple control devices 14. The control device 14 is a computer and controls the injection molding machine 12. The management device 16 is a computer and performs part of the interface processing of individual injection molding machines 12.

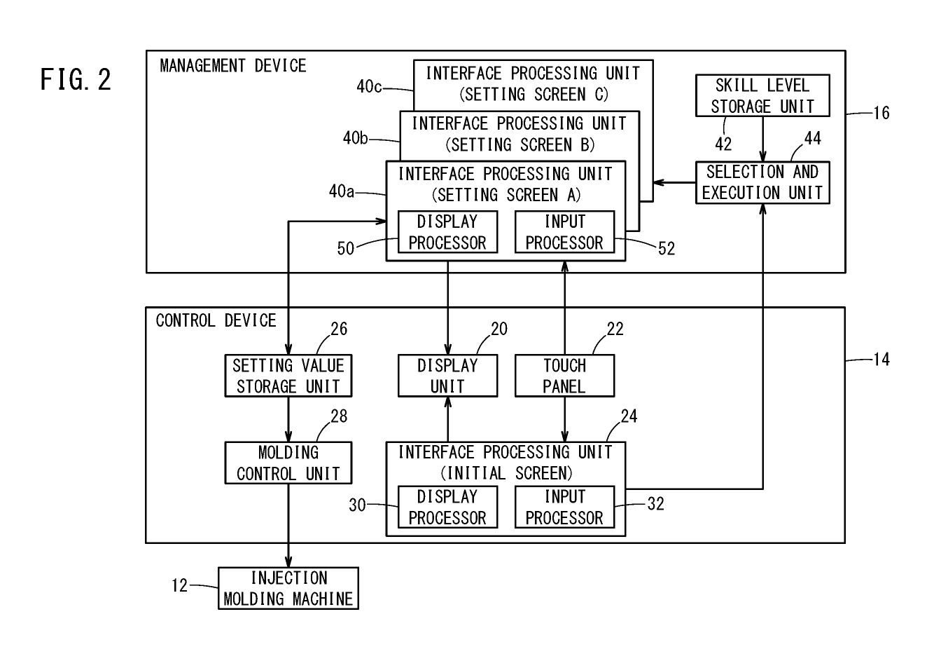

FIG. 2 is a functional block diagram showing a functional configuration of the control device 14 and the management device 16. The control device 14 includes a display unit 20, a touch panel 22 (input information receiving unit), an interface processing unit 24, a setting value storage unit 26 and a molding control unit 28. The display unit 20 is a liquid crystal display or the like, and can display characters, numbers, symbols, images and the like on the screen. The touch panel 22 is a transparent sheet member adhered to the screen of the display unit 20, and is, for example, a resistive film type touch panel. The touch panel 22 detects the position at which the touch panel 22 is pressed by the operator's finger, pen or the like as the touch position coordinates (or operation position coordinates) and outputs the coordinates.

The interface processing unit 24 has a display processor 30 and an input processor 32. The display processor 30 controls the display unit 20 to display a display screen (hereinafter referred to as an initial screen) for allowing the operator to input identification information on the display unit 20. The input processor 32, based on the touch coordinates input through the touch panel 22, calculates the content entered by the operator as input information. Further, the display processor 30 controls the display unit 20 so as to display the calculated input information at a predetermined position on the initial screen of the display unit 20.

The setting value storage unit 26 stores settings (or setting values) of the individual setting items of the injection molding machine 12 designated by the operator. The molding control unit 28 controls the injection molding machine 12 according to the settings designated by the operator.

The management device 16 includes interface processing units 40a to 40c, a skill level storage unit 42 and a selection and execution unit 44. The interface processing units 40a to 40c each have a display processor 50 and an input display processor 52. The display processor 50 controls the display unit 20 so as to display a display screen (hereinafter referred to as a setting screen) for allowing the operator to input settings for the injection molding machine 12. The input display processor 52, based on the touch coordinates input from the touch panel 22, calculates the content entered by the operator as input information. Further, the display processor 50 controls the display unit 20 so as to display the calculated input information at a predetermined position on the setting screen of the display unit 20.

Multiple types of setting screens are prepared according to the skill level of the operator for the operation of the injection molding machine 12. For example, for an operator with a high skill level, the display unit 20 displays a setting screen that allows the operator to designate numerous setting items for the injection molding machine 12. On the other hand, for the operator of a low skill level, the display unit 20 displays a setting screen for enabling the operator to designate limited setting items for the injection molding machine 12. For example, the display processor 50 of the interface processing unit 40a causes the display unit 20 to display a setting screen A for the operator of a high skill level, the display processor 50 of the interface processing unit 40b displays a setting screen B for the operator of a medium skill level on the display unit 20, and the display processor 50 of the interface processing unit 40c causes the display unit 20 to display a setting screen C for the operator of a low skill level.

The skill level storage unit 42 stores the identification information on each operator in association with the operator's skill level for the operation of the injection molding machine 12. The selection and execution unit 44 reads the skill level of the operator corresponding to the identification information input by the operator on the initial screen, from the skill level storage unit 42. Then, the selection and execution unit 44 selects one from the interface processing units 40a to 40c, corresponding to the read skill level and causes the selected interface processing unit 40a, 40b, or 40c to execute processing.

### Processing Flow in Interface Processing Unit

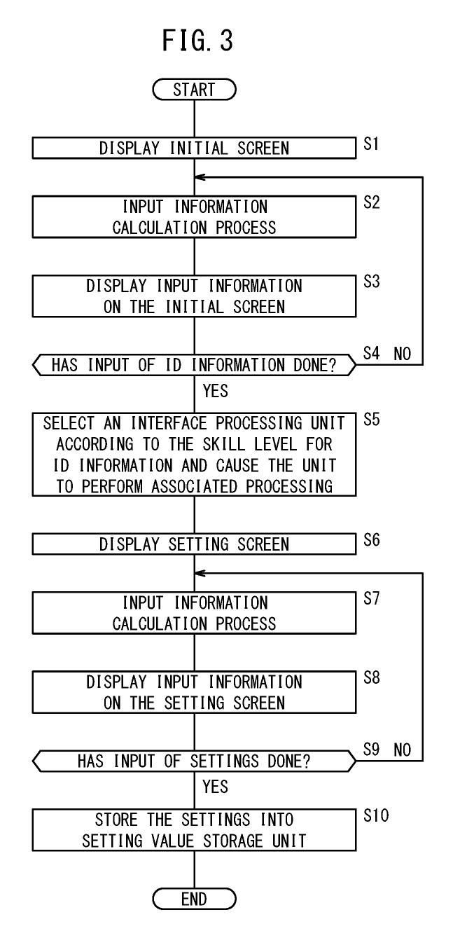

FIG. 3 is a flowchart showing the processing flow performed in the control device 14 and the management device 16. At step S1 the display processor 30 of the interface processing unit 24 controls the display unit 20 so as to display the initial screen on the display unit 20, then the control goes to step S2. Displayed on the initial screen on the display unit 20 are a field for entering operator's identification information, a keyboard for the operator to input his/her identification information and a finish button to be operated by the operator after completing the input of the identification information.

At step S2, the input processor 32 of the interface processing unit 24 calculates as input information the content entered by the operator operating the touch panel 22 in accordance with the touch coordinates on the touch panel 22, then the control proceeds to step S3.

At step S3, the display processor 30 of the interface processing unit 24 controls the display unit 20 so as to display the input information calculated at step S2 in the field for entering the identification information on the initial screen displayed thereon, then the control proceeds to step S4.

At step S4, the input processor 32 of the interface processing unit 24 determines whether or not the finish button on the initial screen has been operated by the operator. When the finish button has been operated, the control goes to step S5. When the finish button is not operated, the control returns to step S2.

At step S5, the selection and execution unit 44 reads the input information input at step S2 as the identification information of the operator, and retrieves the skill level of the operator corresponding to the read identification information from the skill level storage unit 42. Then, the selection and execution unit 44 selects one from the interface processing units 40a to 40c corresponding to the read skill level, and causes the selected interface processing unit 40a, 40b, or 40c to perform associated processing. Then, the control goes to step S6.

At step S6, the display processor 50 in the selected one of interface processing units 40a to 40c controls the display unit 20 so as to display the setting screen thereon, and the control goes to step S7. Displayed on the setting screen on the display unit 20 are fields for entering settings for individual setting items of the injection molding machine 12, a keyboard for the operator to input the settings, and a finish button to be operated by the operator after completing the input of the settings.

At step S7, the input display processor 52 in the selected one of interface processing units 40a to 40c calculates as input information the content entered by the operator operating the touch panel 22 in accordance with the touch coordinates on the touch panel 22, then the control proceeds to step S8.

At step S8, the input display processor 52 in the selected one of interface processing units 40a to 40c controls the display unit 20 so as to display the input information calculated at step S7 in the fields for entering the settings on the setting screen displayed thereon, then the control proceeds to step S9.

At step S9, the input display processor 52 of the selected one of interface processing units 40a to 40c determines whether or not the finish button on the setting screen has been operated by the operator. When the finish button has been operated, the control goes to step S10. When the finish button is not operated, the control returns to step S7.

At step S10, the input display processor 52 in the selected one of interface processing units 40a to 40c outputs, as the settings the input information calculated at step S7, to the setting value storage unit 26 of the control device 14, and makes the setting value storage unit 26 store the settings, and the control is terminated.

### Operation and Effect

It is possible for the operator to designate the settings for numerous setting items in the control device 14 in order to form a necessary molded product by the injection molding machine 12. The setting items may include, for example, the mold clamping force, the cylinder temperature, the rotational rate of the screw and the like. Since an operator of a high skill level for the operation of the injection molding machine 12 has sufficient knowledge for each setting item, he/she can designate suitable settings for molding a necessary molded article. On the other hand, an operator with a low skill level for the operation of the injection molding machine 12 does not have sufficient knowledge for all setting items, so that he/she cannot designate suitable settings for the necessary molded article, hence may fail to set correct values for some setting items.

To avoid this, the setting screen to be displayed on the display unit 20 is configured to be selected from multiple types, depending on the skill level of the operator. For example, displayed for an operator with a high level of skill is a setting screen that allows the operator to designate settings for numerous setting items. On the other hand, for the operator with a low skill level, the display unit 20 displays a setting screen that allows the operator to designate a limited number of setting items. Since skill levels of operators are different, the display unit 20 needs to switch and display various setting screens. In order to control the display unit 20 by the control device 14, the control device 14 needs to hold data on multiple types of setting screens. As a result, the control device 14 entails the problem that the processing load on the control device 14 increases and a large capacity memory is required.

To deal with this, in the present embodiment, the management device 16 connected to the control device 14 is provided with interface processing units 40a to 40c for controlling the display unit 20 so as to display various setting screens on the display unit 20. That is, a multiple number of interface processing units 40a to 40c are provided, corresponding to each type of the setting screen. The selection and execution unit 44 selects one that controls the display unit 20 so as to display a setting screen corresponding to the skill level of the operator on the display unit 20, from the interface processing units 40a to 40c, and makes the selected one of interface processing units 40a to 40c perform its function.

Thus, since the control of the display unit 20 is performed by the interface processing units 40a to 40c provided in the management device 16, the processing load on the control device 14 can be reduced.

Incidentally, there are some cases where in one factory, a large number of injection molding machines 12 are operated. Normally, one control device 14 is provided for one injection molding machine 12. When the control device 14 controls the display unit 20, it is necessary to perform updating work in each control device 14 when software for controlling the display unit 20 is updated, which leads to a problem of increased man-hours.

Controlling the display unit 20 of each control device 14 by means of the interface processing units 40a to 40c in the management device 16 as described above, only needs updating of the software in the management device 16 connected to the multiple control devices 14, which enables reduction in man hours.

### Variational Examples

In the first embodiment, the selection and execution unit 44 reads out the skill level corresponding to the identification information of the operator from the skill level storage unit 42 and selects one of the interface processing units 40a to 40c, which controls the display unit 20 so as to display a setting screen corresponding to the skill level thereon. That is, the selection and execution unit 44 selects one of the interface processing units 40a to 40c according to the operator's identification information. Instead of the operator's identification information, as the information for selection, for the selection and execution unit 44 to select one from the interface processing units 40a to 40c, it is also possible to use the type of the injection molding machine 12, the type of the molded article formed by the injection molding machine 12, the operation mode of the injection molding machine 12 or the like.

The reasons for using different pieces of information for selection as mentioned above are as follows. Each of injection molding machines 12 has different setting items for which settings can be designated, depending on the machine type. Therefore, it is necessary to change the setting screen to be displayed on the display unit 20 according to the type of the injection molding machine 12. Further, the material to be used is different depending on the type of the article to be molded by the injection molding machine 12, and the setting items for which settings are designated are different depending on the type of the article to be molded. Therefore, it is necessary to change the setting screen to be displayed on the display unit 20 according to the type of the molded article formed by the injection molding machine 12.

The operation modes of the injection molding machine 12 may include, for example, a mode in which molding is performed continuously, a mode in which the mold is replaced from one to another or resin is discharged at the time of starting or ending a molding operation, and the like. Since each mode has different setting items to be designated, it is necessary to change the setting screen to be displayed on the display unit 20 according to the operation mode.

Further, information for selection may be given by the operator, i.e., selection of a display screen may be designated by the operator. For example, on the initial screen of the display unit 20, buttons for allowing language selection from those of different countries are displayed so as to allow the operator to touch the touch panel 22 and select one language, whereby display on the display screen is performed in the selected language after language selection.

Though the control device 14 of the first embodiment controls the injection molding machine 12, the control device of the present invention may be applied to those for controlling other industrial machines such as a machining center, a wire electrical discharge machine and the like, not limited to that for injection molding machine 12.

Further, for example, the management device 16 may be installed in a factory where the injection molding machine 12 is installed, or may be installed outside the factory and operate as a cloud server.

### Technical Ideas Obtained from the Embodiments

Technical ideas that can be grasped from the above embodiments will be described below.

The industrial machine system (10) includes: the control device (14) configured to control the industrial machine (12); and the management device (16) connected to the control device (14). In this industrial machine system, the control device (14) includes the display unit (20) configured to display a display screen and the input information receiving unit (22) configured to receive input information entered by an operator. The management device (16) includes the plurality of interface processing units (40a to 40c) provided in association with types of the display screens to be displayed on the display unit (20), and the selection and execution unit (44) configured to select one from the plurality of interface processing units (40a to 40c) according to information for selection for selecting the type of the display screen to be displayed on the display unit (20) and cause the selected interface processing unit (40a to 40c) to execute processing. Each of the selected interface processing units (40a to 40c) is configured to control the display unit (20) so as to cause the display unit (20) to display the associated display screen and display the input information on the display screen of the display unit (20). Thus, since the control of the display unit (20) is performed by the interface processing units (40a to 40c) provided in the management device (16), the processing load on the control device (14) can be reduced.

In the above-mentioned industrial machine system (10), the information for selection may include the identification information of the operator, the type of the industrial machine (12), the type of the product produced by the industrial machine (12), the operation mode of the industrial machine (12) and the type of the display screen selected from the plurality of types of the display screens by the operator. This configuration makes it possible to display a suitable display screen on the display unit (20) according to the information for selection.

In the above-mentioned industrial machine system (10), the industrial machine (12) may be an injection molding machine (12). With this configuration, even when a large number of injection molding machines (12) and control devices (14) are installed in one factory, updating of the software of the interface processing units (40a to 40c) can be done in the management device (16) only, which leads to reduction in man hours.

The control method of the industrial machine system (10) is provided. The industrial machine system (10) includes the control device (14) and the management device (16) connected to the control device (14). The control device (14) is configured to control an industrial machine (12), and includes the display unit (20) configured to display a display screen, and the input information receiving unit (22) configured to receive input information entered by an operator. The control method includes: a selection step of causing the management device (16) to select one from a plurality of types of the display screens, according to information for selection for selecting the type of the display screen to be displayed on the display unit (20); a display screen display processing step of causing the management device (16) to display the selected display screen on the display unit (20); and an input information display step of causing the management device (16) to display the input information on the display screen of the display unit (20). Thus, since the control of the display unit (20) is performed by the interface processing units (40a to 40c) provided in the management device (16), the processing load on the control device (14) can be reduced.

In the above-mentioned control method of the industrial machine system (10), the information for selection may include the identification information of the operator, the type of the industrial machine (12), the type of the product produced by the industrial machine (12), the operation mode of the industrial machine (12) and the type of the display screen selected from the plurality of types of the display screens by the operator. This configuration makes it possible to display a suitable display screen on the display unit (20) according to the information for selection.

In the above-mentioned control method of the industrial machine system (10), the industrial machine (12) may be an injection molding machine (12). With this configuration, even when a large number of injection molding machines (12) and control devices (14) are installed in one factory, updating of the software of the interface processing units (40a to 40c) can be done in the management device (16) side only, which leads to reduction in man hours.

What is claimed is:

1. An industrial machine system comprising:
a control device configured to control an industrial machine; and
a management device connected to the control device, wherein:
the control device includes a display unit configured to display a display screen and an input information receiving unit configured to receive input information entered by an operator;
the management device includes a plurality of interface processing units provided in association with types of the display screens to be displayed on the display unit, and a selection and execution unit configured to select one from the plurality of interface processing units according to information for selection for selecting the type of the display screen to be displayed on the display unit and cause the selected interface processing unit to execute processing; and
each of the selected interface processing units is configured to control the display unit so as to cause the display unit to display the associated display screen and display the input information on the display screen of the display unit.

2. The industrial machine system according to claim 1, wherein the information for selection includes identification information of the operator, a type of the industrial machine, a type of a product produced by the industrial machine, an operation mode of the industrial machine and the type of the display screen selected from the plurality of types of the display screens by the operator.

3. The industrial machine system according to claim 1, wherein the industrial machine is an injection molding machine.

4. A control method of an industrial machine system including a control device and a management device connected to the control device, the control device configured to control an industrial machine and including a display unit configured to display a display screen and an input information receiving unit configured to receive input information entered by an operator,
the control method comprising:
a selection step of causing the management device to select one from a plurality of types of the display screens, according to information for selection for selecting the type of the display screen to be displayed on the display unit;
a display screen display processing step of causing the management device to display the selected display screen on the display unit; and
an input information display step of causing the management device to display the input information on the display screen of the display unit.

5. The control method of the industrial machine system according to claim 4, wherein the information for selection includes identification information of the operator, a type of the industrial machine, a type of a product produced by the industrial machine, an operation mode of the industrial machine and the type of the display screen selected from the plurality of types of the display screens by the operator.

6. The control method of the industrial machine system according to claim 4, wherein the industrial machine is an injection molding machine.
